(19) United States
(12) Patent Application Publication
(10) Pub. No.: US 2012/0177557 A1
(43) Pub. Date: Jul. 12, 2012

(54) PROCESS FOR TREATING CATALYST PRECURSORS

(75) Inventors: Hartwig Rauleder, Rheinfelden (DE); Ekkehard Müh, Rheinfelden (DE); Reinhold Schork, Rheinfelden (DE); Uwe Schön, Rheinfelden (DE)

(73) Assignee: Evonik Degussa Gmbh, Essen (DE)

(21) Appl. No.: 13/383,965

(22) PCT Filed: May 17, 2010
(86) PCT No.: PCT/EP2010/056701

§ 371 Date: Mar. 29, 2012

(30) Foreign Application Priority Data
Jul. 15, 2009 (DE) 102009027728.5

(51) Int. Cl. C01B 33/107; B01J 37/08; B01J 31/06

(52) U.S. Cl. 423/342; 502/159

(57) ABSTRACT

The invention relates to a process for treating a substantially water-containing amino-functional, polymeric catalyst precursor while retaining the inner porous structure thereof and the outer spherical form thereof to form a catalyst, in which the catalyst precursor is treated at mild temperatures and under reduced pressure to prepare a catalyst having a water content below 2.5% by weight. The process is preferably integrated into an industrial scale process for preparing dichlorosilane, monosilane, silane, or solar silicon or semiconductor silicon from silanes.

The invention relates to a process for treating a substantially water-containing amino-functional polymeric catalyst precursor while retaining the inner porous structure thereof and the outer spherical form thereof to form a catalyst, in which the catalyst precursor is treated at mild temperatures and under reduced pressure to prepare a catalyst having a water content below 2.5% by weight. The process is preferably integrated into an industrial scale process for preparing dichlorosilane, monochlorosilane, monosilane or ultrapure silicon from monosilane (SiH₄).

A particularly economical process for preparing monosilane (SiH₄), monochlorosilane (ClSiH₃) and also dichlorosilane (DCS, H₂SiCl₂) from trichlorosilane (TCS, HSiCl₃) with formation of the silicon tetrachloride (STC, SiCl₄) coproduct has been found to be the dismutation reaction. The dismutation reaction to prepare less highly chlorinated silanes, such as monosilane, monochlorosilane or dichlorosilane, from more highly chlorinated silanes, generally trichlorosilane, is performed in the presence of catalysts to more rapidly establish the chemical equilibrium. This involves an exchange of hydrogen and chlorine atoms between two silane molecules, generally according to the general reaction equation (1), in what is known as a dismutation or disproportionation reaction. x here may assume the values of 0 to 3 and y the values of 1 to 4, with the proviso that the silicon atom is tetravalent.

HₓSiCl₄₋ₓ+H_{y}SiCl_{4-y}→Hₓ₊₁SiCl₄₋ₓ₋₁+H_{y-1}SiCl_{4-y+1} (1)

It is customary to disproportionate trichlorosilane over suitable catalysts. The majority of catalysts used are secondary or tertiary amines, or quaternary ammonium salts.

What is crucial when catalysts are used is the avoidance of formation of undesired by-products and of the introduction of contaminants. This is all the more true when ultrapure silicon is to be separated from the silanes. In this case, even impurities in the mass ppb to ppt range are troublesome.

Combination of several successive reactions makes it possible to prepare monosilane by dismutation in three steps—proceeding from trichlorosilane to dichlorosilane via monochlorosilane and finally to monosilane with formation of silicon tetrachloride. The best possible integration of reaction and separation is offered by reactive rectification. The dismutation reaction is a reaction whose conversion is limited by the chemical equilibrium, such that removal of reaction products from the unconverted reactants is required in order to drive the conversion in the overall process to eventual completion.

Typically, commercial catalysts are subjected to a treatment to convert them to their active form. This can be accomplished by hydrogen sparging or modification of the electronic environment of catalytically active sites, for example by oxidation or reduction. In the case of use of hydrous substances as catalysts for catalysis of water-sensitive compounds, the water is advantageously removed to prevent hydrolysis. Catalyst activity in these cases can also frequently suffer from the water content of the system.

To remove the water, which is usually strongly bound to the catalysts by formation of hydrogen bonds, it is typically displaced by other polar aprotic or polar protic solvents. The solvents used are usually organic substances, such as alcohols or ketones, which usually also have to be removed again in subsequent process steps before the use of the catalyst. Such processes have the disadvantage that they have many steps and are laborious as a result. In the cases mentioned, large amounts of mixtures of the solvents and of the displaced water are additionally generated, which have to be worked up in an inconvenient and costly manner.

DE 100 57 521 A1 discloses a dismutation catalyst comprising a divinylbenzene-crosslinked polystyrene resin with tertiary amine groups, which is prepared by direct aminomethylation of a styrene-divinylbenzene copolymer. This catalyst is washed first with high-purity water and then with methanol, especially with boiling methanol. Subsequently, the catalyst is freed of methanol residues by means of otherwise unspecified heating, evacuating or stripping.

It is an object of the present invention to develop an alternative, more ecological process for catalyst preparation that avoids the aforementioned disadvantages. More preferably, the catalyst thus prepared shall be usable in processes for dismutating ultra high-purity halosilanes, especially without decomposing or contaminating these halosilanes.

The object is achieved by a process having the features of claim 1, and the use according to the features of claim 17. Particularly preferred embodiments are set forth in the dependent claims, and detailed in the description.

It has been found that, surprisingly, the process according to the invention allows even porous, water-containing, amino-functional, organic, polymeric catalyst precursors to be treated, especially in a solvent-free method, to form a catalyst under reduced pressure and in the temperature range below 200° C., better below 150° C., with retention of the structure and the catalytic activity and/or activation of the catalytic activity; more particularly, a substantially anhydrous catalyst is obtained. By virtue of the inventive treatment, the porous inner structure and/or the outer shape of the precursors are preserved in the catalyst. The catalytic activity and service life of catalysts treated in this way is outstandingly suitable for dismutation of higher halosilanes on the industrial scale.

Generally, all amino-functionalized divinylbenzene-styrene copolymers can be treated as catalyst precursors by the process according to the invention. Preference is given to treating dialkylamino- or dialkylaminomethyl-functionalized divinylbenzene-styrene copolymers or trialkylammonium- or trialkylammoniomethylene-functionalized divinylbenzene-styrene copolymers by the process according to the invention, in order preferably to be suitable as a dismutation catalyst for halosilanes.

The following formulae illustrate, in idealized form, the structure of the aforementioned functionalized divinylbenzene-styrene copolymers:

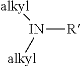

dialkylamino-functionalized
divinylbenzene-styrene copolymer,

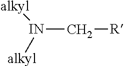

dialkylaminomethylene-functionalized
divinylbenzene-styrene copolymer,

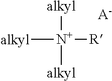

trialkylammonium-functionalized
divinylbenzene-styrene copolymer and

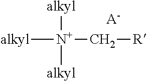

trialkylammoniomethylene-functionalized
divinylbenzene-styrene copolymer,
   where R′ is a polymeric support, especially divinylbenzene-crosslinked polystyrene, i.e. divinylbenzene-styrene copolymer, alkyl is independently methyl, ethyl, n-propyl, i-propyl, n-butyl or i-butyl and K is independently an anion—for example but not exclusively from the group of OH⁻ (hydroxyl), Cl⁻ (chloride), CH₃COO⁻ (acetate) or HCOO⁻ (formate), especially OH⁻.

In addition to the dimethylamino-functionalized divinylbenzene-crosslinked polystyrene resins mentioned, it is also possible to dry further divinylbenzene-crosslinked porous polystyrene resins functionalized with tertiary and/or quaternary amino groups by the process according to the invention. Similarly preferred catalyst precursors include nitrogen-containing basic Lewis compounds which are prepared by polymerization or copolymerization with amino, pyridine, pyrazine, phenazine, acridine, quinoline or phenanthroline groups, and compounds having high specific surface area, for example molecular sieves, polymer-modified molecular sieves or vinyl resins. Preference is given to poly-amino-functionalized porous polymers, especially vinylpyridine polymers (polyvinylpyridines) or vinylpyridine copolymers, such as copolymers with vinylpyridine and styrene or divinylbenzene. The vinylpyridine content is advantageously predominant.

The process according to the invention is found to be particularly suitable for divinylbenzene-crosslinked polystyrene resins having tertiary amino groups as catalyst precursors, such as Amberlyst® A 21, an ion exchange resin based on divinylbenzene-crosslinked polystyrene resin having dimethylamino groups on the polymeric backbone of the resin. It is likewise possible in this way to treat an Amberlyst® A 26 OH, which is based on a quaternary trimethylammonium-functionalized divinylbenzene-styrene copolymer and has a highly porous structure. The mean particle diameter of the catalysts is typically 0.5 to 0.6 mm.

Even in the presence of large amounts of enclosed readily or else sparingly volatile substances, such as water, in the cavities of porous to macroporous catalyst precursors (pore diameter greater than 200 Angström), as in the case of Amberlyst® A 21, catalysts can be prepared by treating the precursors under reduced pressure—synonymous to vacuum—and optionally with a moderate thermal treatment up to below 200° C. Preference is given to treatment below 150° C. The catalysts thus prepared are obtained with retention of structure, i.e. with retention of the inner and/or outer structure or morphology and habit of the catalyst precursors to be activated.

It has been found that a purely thermal treatment of the catalyst precursors for substantially complete removal of sparingly volatile substances, such as water, is not an option. The active sites and the organic support materials usually used, such as divinylbenzene-styrene copolymers, the crude catalysts or catalyst precursors, cannot be exposed to high temperatures over a long period without structural alterations and/or decompositions, as shown in the examples.

As the catalyst for the dismutation of halosilanes, it is additionally necessary for safety reasons, owing to the ignitability of the silanes, and to prevent the contamination of the silanes, to prevent contact with oxygen. Contact of the silanes with water can additionally result in troublesome solid silicon dioxide deposits which can impair the catalyst activity.

The invention therefore provides a process for treating a water-containing, amino-functional, organic, polymeric catalyst precursor, especially solvent-free catalyst precursor, to form a catalyst, by treating the catalyst precursor below 200° C. and under reduced pressure (i.e. a pressure reduced relative to standard pressure or ambient pressure) to obtain a catalyst, preferably having a water content of below 2.5% by weight, preferentially having a water content in the range from 0.00001 to 2% by weight. According to the invention, “organic” is understood to mean a catalyst precursor which at least partly comprises organic compounds. These are generally amino-functionalized polymers or copolymers.

It is particularly preferred when the water-containing catalyst precursor is treated under a dried gas or gas mixture under reduced pressure. Typically, air or an inert gas can be used, the residual moisture content of which is preferably below 1000 ppm (by mass), for example in the range from 1000 ppm to 0.01 ppt, especially below 200 ppm, more preferably below 50 ppm, especially preferably below 5 ppm.

For an optimal treatment of the catalyst precursors, the treatment is effected under a flowing gas or gas mixture, preferably under an inert gas atmosphere, especially under a flowing inert gas atmosphere under reduced pressure. The gas flow or inert gas flow may preferably be in the range from 0.0001 to 10 m³/h, more preferably in the range from 0.0001 to 1.5 m³/h, values around 0.5 to 1.25 m³/h being preferable on the industrial scale.

The invention relates more particularly to a process for treating a substantially water-containing amino-functional catalyst precursor while maintaining the inner and/or outer structure thereof, especially the inner porous structure and the outer shape thereof, to form a catalyst, by treating the catalyst precursor at mild temperatures and under reduced pressure to prepare a substantially anhydrous catalyst, especially having a water content below 2.5% by weight, preferably 0.00001 to 2% by weight. Preference is given to treatment below 100° C. at a pressure in the range from 0.001 to 100 mbar, preferably in the range from 0.001 to 70 mbar. The range of variation of the determinable water content may be plus/minus 0.3% by weight.

The water content can be determined, for example, according to Karl Fischer (Karl Fischer Titration, DIN 5 777). The water contents of the amino-functional catalysts which can be established by the process according to the invention are advantageously in the range from 0 (i.e. undetectable by KF, and 2.5% by weight, especially in the range from 0.0001% by weight to 2% by weight, preferably in the range from 0.001 to 1.8% by weight, more preferably in the range from 0.001 to 1.0% by weight, further preferably in the range from 0.001 to 0.8% by weight, better in the range from 0.001 to 0.5% by weight, 0.001 to 0.4% by weight or 0.0001 to 0.3% by weight. At the same time, the inventive combination of process steps allows the retention of the structure of the catalyst with avoidance of use of organic solvents.

The process is preferably an industrial scale process, preferably integrated into or assigned to an industrial scale process for preparing dichlorosilane, silane, up to and including solar or semiconductor silicon from silanes. In general, the process can be assigned to the processes mentioned as a batchwise process in the cycle of the catalyst service lives.

A substantially water-containing amino-functional catalyst precursor generally contains more than 10% by weight of water in relation to the total weight thereof. The water content may be up to 60% by weight and higher, especially in the case of a water-washed and optionally filtered catalyst precursor. It may be preferable to wash the water-containing catalyst precursor, before the treatment, with water, especially demineralized or deionized water, for example by means of a pressure wash. Displacement of the water by solvents can preferably be dispensed with by the process according to the invention.

Similarly, the water-containing, amino-functional catalyst precursor can also actually be formed by washing with water before the inventive treatment, for example from a crude catalyst which, owing to its contamination profile, cannot be used in the processes for preparing or dismutating high-purity silanes. This is particularly relevant in the case of dismutation of halosilanes to less highly halogenated silanes or to monosilane, especially as starting materials for production of solar or semiconductor silicon.

For this application, the crude catalyst is washed with distilled, bidistilled, preferably with high-purity, deionized water, and is then present as the catalyst precursor. The water content of the precursor, as a result of this measure, may be significantly greater than 10% by weight in relation to the total weight, especially up to 80% by weight. In general, the water content is around 30 to 70% by weight, preferably around 45 to 60% by weight, in relation to the total weight.

Given these high water contents of the catalyst precursors, a sensitive adjustment of the drying process is necessary in order to dry the thermally sensitive, amino-functional catalyst precursor without decomposition or without impairment of the catalyst activity on the industrial scale to obtain a catalyst which is preferably suitable for the disproportionation mentioned. Highly problematic factors in the treatment of the catalyst precursors are decomposition reactions, transmutations or exudance in the course of treatment of the catalyst precursors.

It is additionally preferred when the water-washed or the untreated catalyst precursor is used in substantially solvent-free form in the process according to the invention. The catalyst precursor is considered to be substantially solvent-free when the precursor or the crude catalyst has not been treated additionally with a solvent or a mixture comprising a solvent, such as an alcohol.

In one alternative, a preferred process for preparing the catalyst comprises the steps of 1) washing a catalyst precursor or a crude catalyst with water to form the catalyst precursor, especially washing a customary commercial catalyst, preferably an amino-functional catalyst, preferably with distilled water, more preferably with high-purity, deionized water; in step 2), the water-containing catalyst precursor is prepared without further treatment to form the catalyst by applying reduced pressure or vacuum and optionally while regulating the temperature, especially in the temperature range up to 200° C.; and optionally, in a step 3), the vacuum is broken by means of inert gas or dried air; and the catalyst is obtained after step 2) or 3). In a further step, the catalyst can be contacted with a halosilane for dismutation. The regulation of the temperature under applied vacuum preferably ensures a temperature range from 15° C. to 200° C. during the treatment. The precursor is preferably treated under vacuum at elevated temperature, more preferably below 150° C. In one alternative, the process can also be performed without step 1).

In a particularly advantageous embodiment of the process, the catalyst is prepared by treating an amino-functional, porous and water-containing catalyst precursor, optionally substantially with retention of the inner and/or outer structure. The water content of the precursor may be up to 60% by weight. More particularly, the porous structure and/or the outer structure, preferably the inner and/or outer structure or shape, especially the surface of the catalyst (precursor) is substantially preserved after the removal of the water.

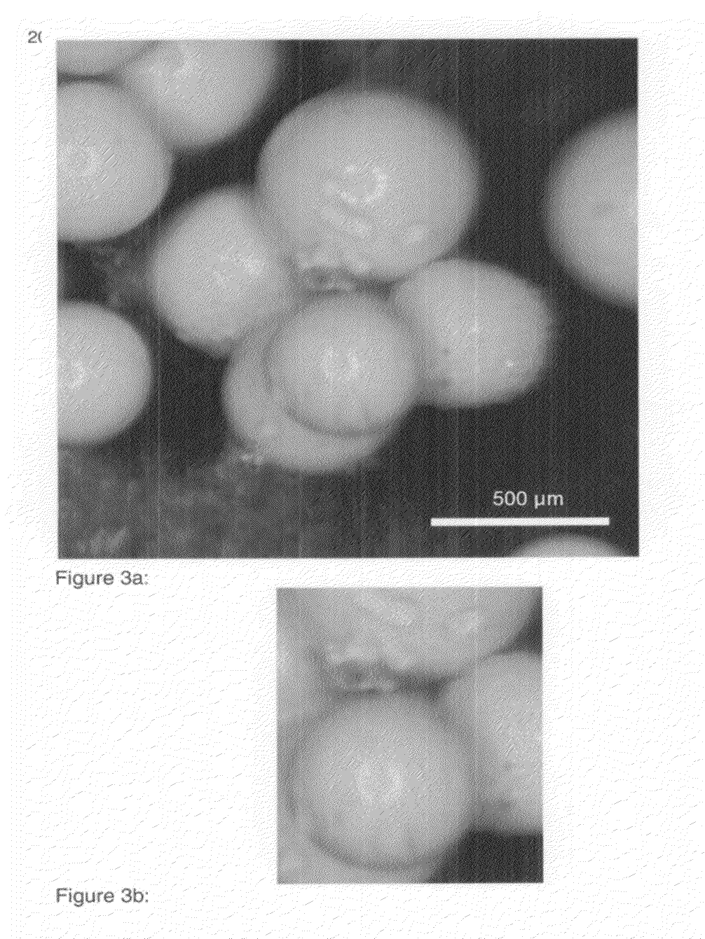

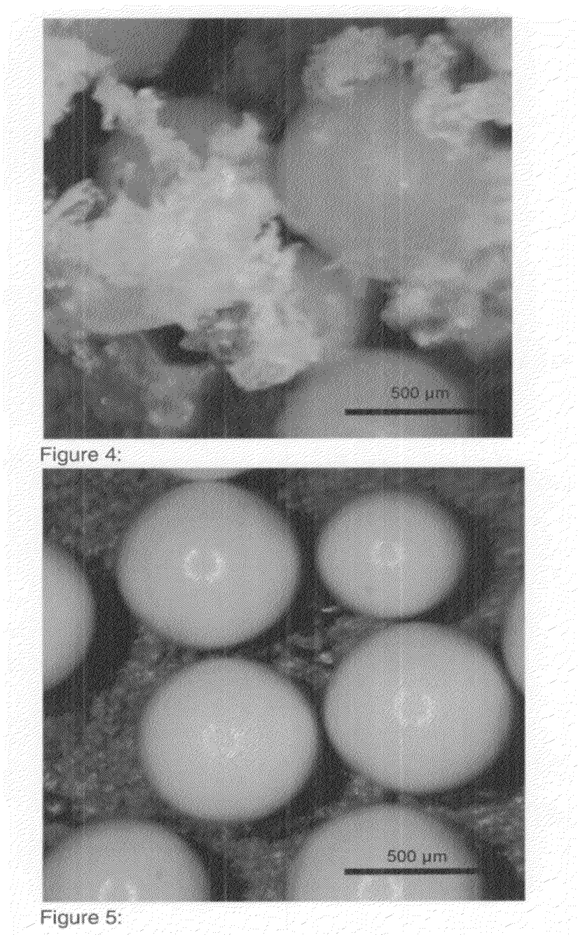

The retention of the structure, especially of the porous inner structure and also of the outer shape, is essential for the activity of the catalyst and for a very long service life in the reactor. The accessibility of the active sites must be ensured for the catalyst activity, as must good flow of the reactant fluids, i.e. of liquid or gaseous substances through and around. The active sites of the catalysts remain accessible to the substances to be converted and active. A collapse of the structure or a decomposition of the thermally sensitive materials of the catalyst precursors should be avoided in any case. In the case of a customary, purely thermal drying of the catalyst precursor, the structure changes in the course of treatment; more particularly, it has been found that the porous structures become blocked with exuding crystalline substances. This becomes particularly clear visually by crystalline deposits, or generally by deposits on the outer surface of the particulate catalysts of FIGS. 3 and 4 after purely thermal drying.

The elimination of the reduced pressure or of the vacuum with inert gas, especially with nitrogen, argon or helium, allows the catalyst to be prepared in a substantially oxygen-free manner. Partial oxidation of the active sites can impair the catalytic activity and constitutes, as detailed at the outset, a safety risk in the preparation of monosilane. This is especially true of Amberlyst® A 21 for preparation of the catalyst actually usable for dismutation of high-purity halosilanes.

High-purity halosilanes are understood to mean those whose contamination profile in the sum total of all contaminants, especially of all so-called “metallic” contaminants, is below 1 ppm to 0.0001 ppt, preferably 100 ppb to 0.0001 ppt, more preferably 10 ppb to 0.0001 ppt, better 1 ppb to 0.0001 ppt (by mass). Generally, such a contamination profile is desired for the elements iron, boron, phosphorus and aluminium.

The process for treatment of the catalyst precursor under reduced pressure thus also comprises breaking the vacuum by means of a gas or gas mixture, as with dried air or an inert gas, especially with dried inert gas. In one process variant, the catalyst precursor can be stored under inert gas even prior to the establishment of the reduced pressure. Preference is given to passing an inert gas stream over the catalyst precursor and then establishing the reduced pressure.

It has been to be particularly advantageous when the catalyst precursor, the catalyst or the mixture of the two is agitated in the course of the treatment.

After the inventive treatment, the catalyst, especially at room temperature, can be contacted with a halosilane. According to the invention, the catalyst prepared or obtainable by the process is suitable for dismutating hydrogen- and halogen-containing silicon compounds of the general formula I, especially high-purity halosilanes HₙSiₘX₍₂ₘ₊₂₋ₙ₎ (I) where X is independently fluorine, chlorine, bromine and/or iodine, and n and m are each integers such that 1≦n<(2m+2) and 1≦m≦12. m is preferably 1 or 2, more preferably 1, when X is chlorine. The catalyst is therefore more preferably suitable for dismutating HSiCl₃, H₂SiCl₂, H₃SiCl or mixtures containing at least two thereof.

The catalyst precursor is treated preferably within the temperature range from −196° C. to 200° C., especially from 15° C. to 175° C., preferably from 15° C. to 150° C., more preferably from 20° C. to 135° C., even more preferably from 20° C. to 110° C., particular preference being given here to the temperature range from 20° C. to 95° C. Typically, the treatment is performed after the establishment of the temperature in the temperature range from 60° C. to 140° C., especially from 60° C. to 95° C., i.e. especially at 60, 65, 70, 75, 80, 85, 90, 95° C., and also all intermediate temperature values in each case, preferably under reduced pressure and optionally with agitation of the catalyst precursors or of the resulting mixture of catalyst and precursor.

It is preferred when the treatment is effected under reduced pressure in the range from 0.0001 mbar to 1012 mbar (mbar absolute). More particularly, the reduced pressure is in the range from 0.005 mbar to 800 mbar, preferably in the range from 0.01 mbar to 600 mbar, more preferably in the range from 0.05 to 400 mbar, further preferably in the range from 0.05 mbar to 200 mbar, more advantageously in the range from 0.05 mbar to 100 mbar, especially in the range from 0.1 mbar to 80 mbar, better in the range from 0.1 mbar to 50 mbar, even better in the range from 0.001 to 5 mbar; the pressure is even more preferably below 1 mbar. Preference is given to establishing a reduced pressure or vacuum in the range from 50 mbar to 200 mbar, preferably down to less than 1 mbar and 50 mbar at elevated temperature, especially at 15° C. to 180° C., more preferably in the range from 20° C. to 150° C.

For amino-functional, water-containing catalyst precursors, a treatment within the temperature range from 80° C. to 140° C. under a reduced pressure are 50 mbar to 200 mbar down to less than 1 mbar has been found to be particularly advantageous for establishment of a water content of less than 2% by weight, preferably of less than 0.8% by weight to less than 0.5% by weight, with simultaneous retention of the structure. In addition, under these conditions, the drying can be effected within an acceptable process duration on the industrial scale.

A further particular advantage of the process according to the invention is that even on an industrial scale it ensures retention of the structure of the catalyst precursors to be activated. Advantageously, per process batch, 1 kg to 10 t, especially 1 to 1000 kg, preferably 10 to 500 kg, of catalyst precursor can be dried without suffering any significant structural changes or decomposition.

To perform the process according to the invention, the treatment can be effected in apparatus comprising a receptacle, especially a reactor, a vessel or container, having a device for filling and optionally for emptying the apparatus and a device for removing liquid or gaseous substances. With the aid of the device for filling and optionally for emptying the apparatus, the catalyst precursor can be introduced, the reactants can be added batchwise or continuously, and the spent catalyst can be removed later. According to the invention, the apparatus is suitable for operation under the reduced pressures specified above, under standard pressure or else under elevated pressure. In addition, the container is preferably assigned a heating and/or cooling apparatus. Advantageously, the container is assigned a stirrer apparatus and/or is rotatable. The apparatus also has an inert gas supply. Particularly preferred apparatuses for performing the process according to the invention include a paddle dryer, filter dryer or stirred reactor assigned a vacuum system, a heating and/or cooling apparatus and inert gas supply.

The invention also provides for the use of a paddle dryer, filter dryer or stirred reactor assigned a vacuum system, a heating and/or cooling apparatus and inert gas supply, for preparing a catalyst from a water-containing, amino-functionalized catalyst precursor.

The invention likewise provides for the use of a catalyst prepared by the process according to the invention for dismutating chlorosilanes, especially for preparing dichlorosilane, monochlorosilane or monosilane from more highly substituted chlorosilanes. The catalyst prepared can preferably be used for dismutation of (i) trichlorosilane to obtain monosilane, monochlorosilane, dichlorosilane and tetrachlorosilane or a mixture comprising at least two of the compounds mentioned, or (ii) dichlorosilane can be used to obtain monosilane, monochlorosilane, trichlorosilane and silicon tetrachloride or a mixture of at least two of the compounds mentioned.

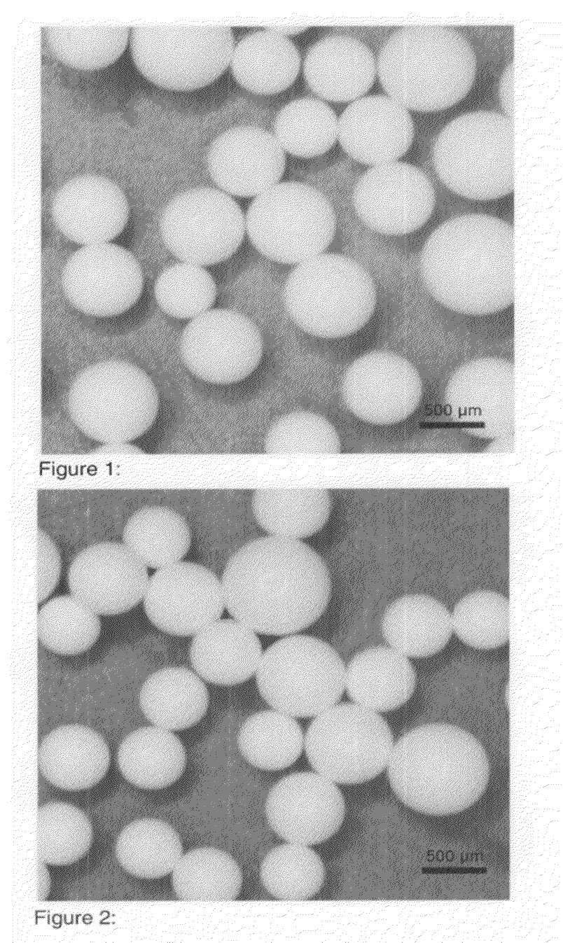

The examples which follow illustrate the process according to the invention without restricting the process thereto. FIGS. 1 to 5 show visual changes in the habit and in the morphological properties of Amberlyst® A 21 (approximately 25 m²/g, mean pore diameter 400 Angström) before and after the treatment methods described hereinafter.

FIG. 1: Catalyst after drying at 130° C. and 10 to 20 mbar for 5 h (marking 500 μm).

FIG. 2: Undried catalyst (marking 500 μm).

FIG. 3: Catalyst after drying at 175° C. for 5 h with exudance (marking 500 μm).

FIG. 4: Catalyst after drying at 250° C. for 5 h with crystalline exudance (marking 500 μm).

FIG. 5: Undried catalyst (greater resolution; marking 500 μm).

### EXAMPLE SERIES 1

### Example 1.1

80.1 g of Amberlyst® A21 (Rohm Haas) with a starting water content of approx. 55% by weight is weighed into a 500 ml four-neck flask with jacketed coil condenser and stirrer. The drying is effected at about 95° C. pot temperature in an oil bath over 8 h at a pressure <1 mbar (rotary vane pump). This is followed by exposure to dry nitrogen and cooling to ambient temperature. The water content of the dried catalyst was determined by means of Karl Fischer titration (DIN 51 777) and is 0.3% by weight.

Performance testing of the catalyst: 29.1 g of the dried catalyst were blanketed with 250 ml of trichlorosilane (GC>99.9%) in a flask with condenser and gas outlet, and a sample was taken for GC after 5 h. In addition to trichlorosilane 87.8 (GC %), silicon tetrachloride and the readily volatile dichlorosilane and monochlorosilane reaction products dissolved in the mixture are present.

### Comparative Example 1.2

Performance testing of the untreated Amberlyst® A21 catalyst with a starting water content of approx. 55% by weight. 1 g of the catalyst was initially charged in a flask with thermometer, condenser and gas outlet, and 10 ml of silicon tetrachloride were metered in by means of a 25 ml dropping funnel. A strong reaction ensued immediately, which was accompanied by a temperature increase from 24 to 37° C. and formation of HCl mist, until the water had finished reacting with the silicon tetrachloride. An analysis of the reaction mixture showed that various siloxanes and condensation products up to and including silica deposits had formed. In its original form, the catalyst is unsuitable for the conversion of hydrolysis-sensitive substances, for example trichlorosilane.

### EXAMPLE SERIES 2

The catalysts prepared according to the description in Examples 1.1, 3.1, 3.2, 3.3, 4.1, 4.2 and 4.3 were examined for their catalytic activity.

To this end, a 250 cm³ four-neck flask with dropping funnel, internal thermometer, septum for sampling and gas outlet was initially charged with 20 g of the particular catalyst, and 100 g of trichlorosilane (TCS) were added rapidly in a water bath at 30-31° C. with constant stirring by means of a magnetic stirrer. After given measurement times, samples were taken through the septum with the aid of a GC syringe, and analysed by means of GC for the formation of the dismutation products, especially of the sparingly volatile silicon tetrachloride (SiCl₄).

The gaseous products which escape through the gas outlet (including monosilane formed) were introduced into sodium methoxide solution.

The catalysts prepared according to the description 1.1, 3.2, 3.3, 4.1 all exhibited a comparatively high dismutation activity. The catalyst prepared according to 3.1 exhibited moderate dismutation activity, the catalysts according to 4.2 and 4.3 exhibited only low catalytic activity, and the catalyst according to 4.3 had the lowest activity.

### EXAMPLE SERIES 3

General procedure for tests: a 2 l round flask was initially charged with 300 g of Amberlyst® A 21 catalyst dried by the procedure described in the individual examples (approx. 50% of the flask volume), and then 1500 g of SiCl₄ were added via a dropping funnel within one minute. The temperature profile was monitored using a thermometer.

### Example 3.1

1 kg of the untreated Amberlyst® A21 catalyst with a starting water content of approx. 55% by weight was dried in rotary evaporator at 110° C. at ambient pressure over 11 hours. The water content was determined by means of Karl Fischer titration (DIN 51 777) to be 1.7%.

When SiCl₄ was added, a vigorous reaction was observed. The flask contents heated up very strongly to more than 110° C., accompanied by significant gas evolution and bumping.

### Example 3.2

350 kg of the untreated Amberlyst® A21 catalyst with a starting water content of approx. 55% by weight were dried in a 1 m³ paddle dryer at 90° C. over 12 hours at 20 revolutions/min. In the course of this, dry nitrogen was blown in through the dryer base with a flow rate of 1 m³/h, and the vacuum was lowered gradually from 60 mbar down to <1 mbar. The water content was determined by means of Karl Fischer titration (DIN 51 777) to be 0.5%. When SiCl₄ was added, the flask contents warmed up slightly to max. 40° C., in the course of which only minor gas evolution was observed.

### Example 3.3

350 kg of the untreated Amberlyst® A21 catalyst with a starting water content of approx. 55% by weight were dried at a 1 m³ paddle dryer at 130° C. over 16 hours at 20 revolutions/min. In the course of this, the volume was blanketed over the catalyst to be dried with dry nitrogen with a flow rate of 0.5 m³/h, and a vacuum of 150 mbar was established. The water content was determined by means of Karl Fischer titration (DIN 51 777) to be 0.4%. When SiCl₄ was added, the flask contents heated up slightly to max. 38° C., in the course of which only minor gas evolution was observed.

Result of test series 3: The effects which occur at elevated residual moisture contents, such as an increase in temperature to more than the boiling point of the chlorosilanes used and gas evolution, lead to great problems on the industrial scale, which greatly restrict or make impossible the use of the catalysts.

### EXAMPLE SERIES 4

### Example 4.1

Morphological studies: 300 g of the untreated Amberlyst® A21 catalyst with a starting water content of approx. 55% by weight were dried in a rotary evaporator at 130° C. at a pressure of 20-10 mbar over 5 h. The water content was determined by means of Karl Fischer titration (DIN 51 777) to be 0.5%.

A sample of the dried catalyst was studied by means of light microscopy (FIG. 1) and compared with an undried sample (FIG. 2). It is evident that the spherical, visually very smooth surface of the catalyst spheres does not change in the course of this drying method. The catalyst thus dried exhibits good activity in the activity test; see example series 2.

### Examples 4.2 and 4.3

300 g of the untreated Amberlyst® A21 catalyst with a starting water content of approx. 55% by weight were dried in each case in a rotary evaporator with a Marlotherm oil bath at 175° C. or 250° C. at ambient pressure over 5 h. The water content was determined by means of Karl Fischer titration (DIN 51 777) to be 1.5 or 1.2%. In the case of the catalyst sample dried at 175° C., slight exudance of crystalline appearance were observed under the light microscope (FIG. 3). The sample dried at 250° C. exhibited significant crystalline exudance (FIG. 4), and an increasing brown colour of the otherwise yellowish spheres. FIG. 5 shows, for comparison, the image of an undried sample in appropriate magnification.

Compared to the catalyst dried at 130° C. and 20 to 10 mbar, the catalysts dried at high temperatures exhibited lower activity, and the catalyst dried at 250° C. exhibits the lowest activity.

1. A process for producing a catalyst, the process comprising:
treating a water-comprising, amino-functional, polymeric, organic catalyst precursor at a temperature below 200° C. and under reduced pressure, to obtain a catalyst having a water content below 2.5% by weight.

2. The process of claim 1, wherein the treating is carried out with a dried gas or gas mixture under reduced pressure.

3. The process of claim 1, wherein the catalyst precursor is substantially solvent-free.

4. The process of claim 1, further comprising, after the treating, increasing the pressure by breaking vacuum with at least one selected from the group consisting of an inert gas and air.

5. The process of claim 1, further comprising, during the treating, agitating at least one selected from the group consisting of the catalyst precursor and the catalyst.

6. The process of claim 1, wherein the catalyst precursor comprises a tert-amino-functional divinylbenzene-styrene copolymer or a quaternary-ammonium-functional divinylbenzene-styrene copolymer.

7. The process of claim 1, wherein the catalyst substantially retains at least one selected from the group consisting of an inner structure and an outer structure of the catalyst precursor.

8. The process of claim 1, further comprising, prior to the treating:
washing a crude catalyst with water, to form the catalyst precursor.

9. The process of claim 1, wherein the catalyst is suitable for dismutating at least one selected from the group consisting of HSiCl₃, H₂SiCl₂, and H₃SiCl.

10. The process of claim 1, the treating is effected in a temperature range from −196° C. to 175° C.

11. The process of claim 1, wherein the reduced pressure is in a range from 0.001 mbar to 1012 mbar.

12. The process of claim 1, the treating is effected in an apparatus comprising:
a vessel;
a first device for charging the apparatus;
optionally, a second device for emptying the apparatus, and
a third device for removing a liquid or a gaseous substance.

13. The process according of claim 12, wherein the vessel further comprises at least one selected from the group consisting of a heater and a cooler.

14. The process of claim 10, wherein the apparatus is suitable for operation under elevated pressure, standard pressure, and reduced pressure.

15. The process of claim 10, wherein the vessel further comprises a stirrer, the vessel is rotatable, or both.

16. The process of claim 10, the apparatus further comprises:
a paddle dryer, a filter dryer, or a stirred reactor comprising a vacuum system;
at least one selected from the group consisting of a heater, and a cooler; and
an inert gas supply.

17. A process for producing a chlorosilane, the process comprising:
dismutating a chlorosilane with a catalyst prepared by the process of claim 1, to obtain a dismutated silane.

18. The process of claim 17, wherein the dismutated silane is at least one selected from the group consisting of dichlorosilane, monochlorosilane, and monosilane, and the chlorosilane a trichlorosilane or silicon tetrachloride.

19. The process of claim 8, further comprising, after to the treating:
increasing the pressure by breaking vacuum with an inert gas.

20. The process of claim 1, wherein the treating is effected in a temperature range from 20° C. to 95° C.
